(19) United States
(12) Patent Application Publication
(10) Pub. No.: US 2009/0223069 A1
(43) Pub. Date: Sep. 10, 2009

(54) LOWER BLADE GUARD

(75) Inventor: James R. Parks, White Hall, MD (US)

Correspondence Address: Harness Dickey & Pierce, P.L.C., P.O. Box 828, Bloomfield Hills, MI, 48303, US

(73) Assignee: BACK & DECKER INC., Newark, DE (US)

(21) Appl. No.: 12/042,401

(22) Filed: Mar. 5, 2008

(51) Int. Cl. B23D 45/16; B27B 9/00; B25F 5/02

(52) U.S. Cl. 30/391

(57) ABSTRACT

A power tool for cutting a workpiece including a casing, an auxiliary handle assembly extending from the casing, a motor disposed at least partially in the casing, and a drive transmission operably coupled to the motor. The drive transmission outputs a driving force to a circular cutting blade in response to an input from the motor. The power tool further includes a movable blade guard pivotally coupled about an axis relative to the casing. The movable blade guard includes an inboard surface, an outboard surface, and an edge surface defining a cavity for receiving the circular cutting blade. The outboard surface defines a cam having a camming tip and a camming portion. The camming portion extends substantially along a radial line from the axis.

### FIELD

The present disclosure relates to various improvements for power tools and, more particularly, relates to a lower blade guard, gear transmission system, and spindle lock mechanism for a power tool.

### BACKGROUND AND SUMMARY

The statements in this section merely provide background information related to the present disclosure and may not constitute prior art.

Circular cutting saws are commonly used in both residential and commercial applications. These circular saws typically include a motor casing surrounding a motor drive system. The circular saw may also include one or more handles for manipulating the saw prior to, during, and after operation. Conventional motor drive systems can include a motor operably driving a transmission coupled to a circular cutting blade or other implement. Although transmissions vary widely in the art, some include a worm drive system, which is often characterized by the use of a worm and wheel gearing system, oil bath coolant and lubrication, and an overall long, narrow aspect ratio of the motor casing in comparison to other circular saw designs.

According to some embodiments of the present teachings, a power tool for cutting a workpiece is provided having a number of advantageous features over conventional power tool designs. In some embodiments, a power tool is provided for cutting a workpiece. The power tool can include a casing, an auxiliary handle assembly extending from the casing, a motor disposed at least partially in the casing, and a drive transmission operably coupled to the motor. The drive transmission outputs a driving force to a circular cutting blade in response to an input from the motor. The power tool further includes a movable blade guard pivotally coupled about an axis relative to the casing. The movable blade guard includes an inboard surface, an outboard surface, and an edge surface defining a cavity for receiving and, at least, partially concealing the circular cutting blade. The outboard surface of the movable blade guard defines a cam having a camming tip and a camming portion. The camming portion extends substantially along a radial line from the axis.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a front perspective view of an exemplary worm drive saw having a spindle lock, gear transmission system, and lower blade guard according to the principles of the present teaching;

FIG. 2 is a rear perspective view of the exemplary worm drive saw illustrating the spindle lock and increased rip guide clearance according to the principles of the present teaching;

FIG. 3 is a front view of the exemplary worm drive saw;

FIG. 4 is a rear view of the exemplary worm drive saw;

FIG. 5 is a bottom view of the exemplary worm drive saw;

FIG. 6 is a top view of the exemplary worm drive saw;

FIG. 7 is a left view of the exemplary worm drive saw;

FIG. 8 is a right view of the exemplary worm drive saw;

FIG. 9 is a plan view of a conventional lower blade guard;

FIG. 10 is a plan view of an exemplary lower blade guard according to the principles of the present teachings;

FIG. 11 is a perspective view of the exemplary lower blade guard;

FIG. 12 is an isometric plan view of the exemplary lower blade guard;

FIG. 13 is a lower perspective view of the exemplary worm drive saw illustrating the exemplary lower blade guard engaging a workpiece;

FIG. 14 is an enlarged perspective view illustrating the rip guide clearance of a conventional worm drive saw;

FIG. 15 is an enlarged perspective view illustrating interference between the conventional worm drive saw and a rip guide member;

FIG. 16 is a side view of a conventional output shaft having a spindle lock formed thereon;

FIG. 17 is a side view of an armature shaft and associated components of a drive transmission according to the principles of the present teachings, with portions removed for clarity;

FIG. 18 is a partial cross sectional view of an output shaft and associated components of the drive transmission taken along line 18-18 of FIG. 6 according to the principles of the present teachings;

FIG. 19 is an enlarged perspective view of a spindle lock mechanism according to the principles of the present teachings;

FIG. 20 is an enlarged perspective view of the spindle lock mechanism partially disposed in the casing of the exemplary worm drive saw;

FIG. 21 is a perspective view of a fan hub having a hub portion for receiving a spindle lock member therein; and

FIG. 22 is an enlarged perspective view illustrating the increased rip guide clearance of the exemplary worm drive saw.

### DETAILED DESCRIPTION

The following description is merely exemplary in nature and is not intended to limit the present disclosure, application, or uses. It should be understood that throughout the drawings, corresponding reference numerals indicate like or corresponding parts and features.

It should further be understood that although many aspects of the present teachings are discussed and described in connection with a worm drive circular saw, the principles of the present teachings are equally applicable to other power tools, such as, but not limited to, conventional circular saws (as opposed to worm drive saws).

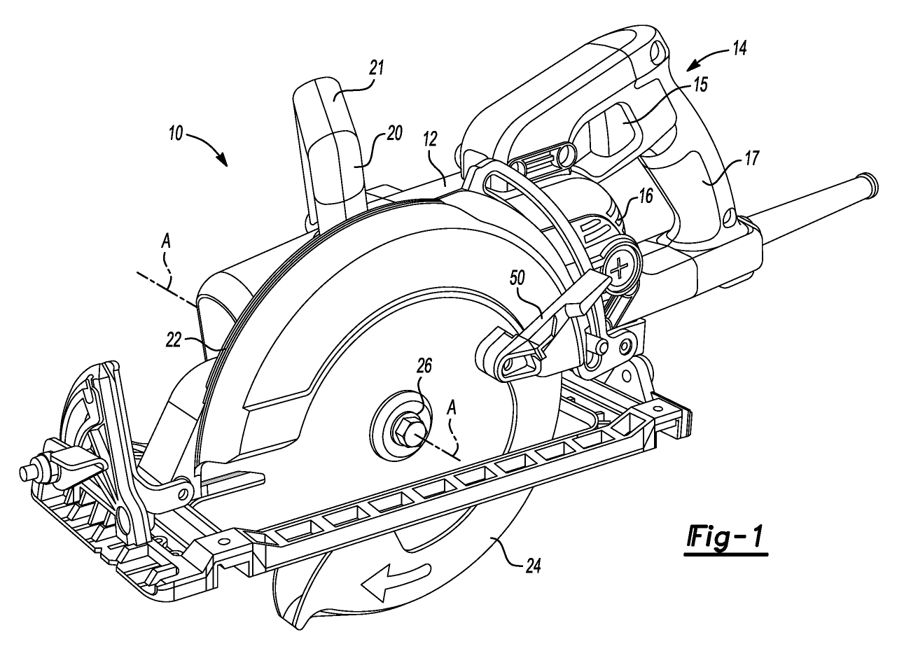

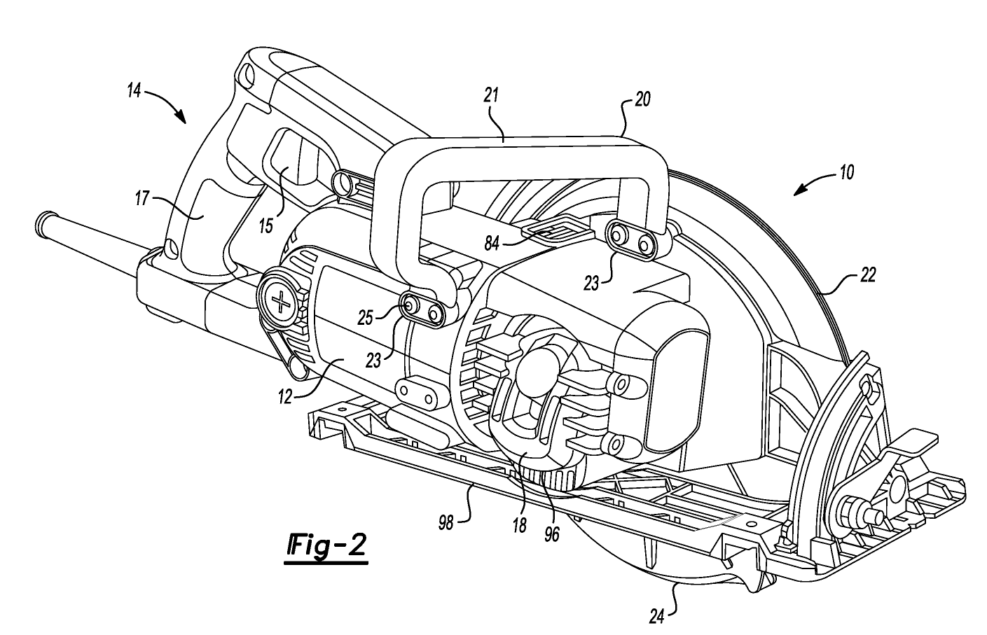

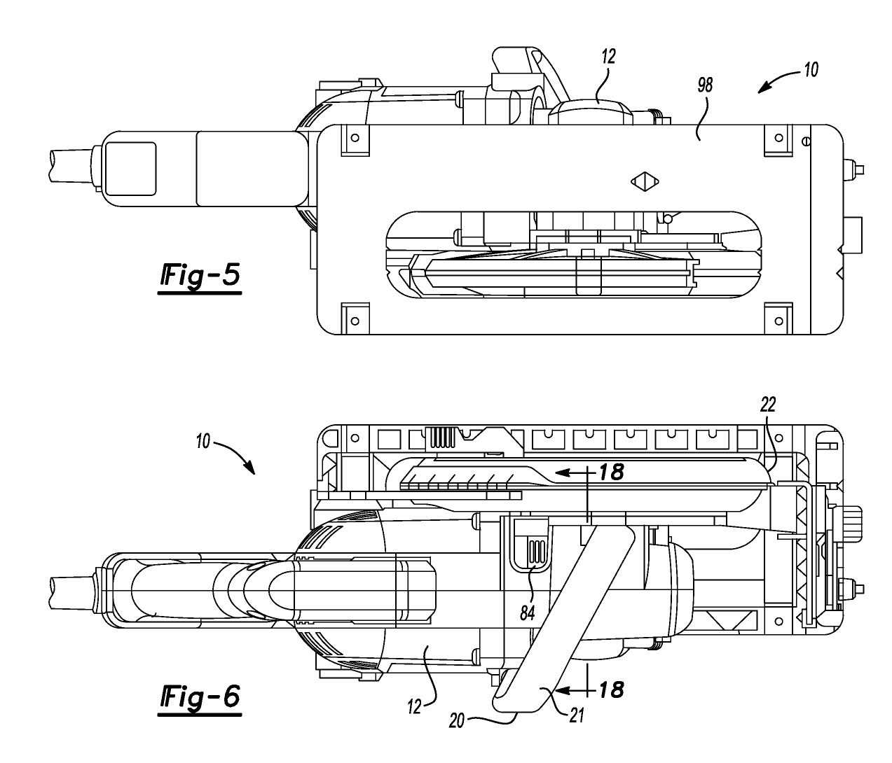

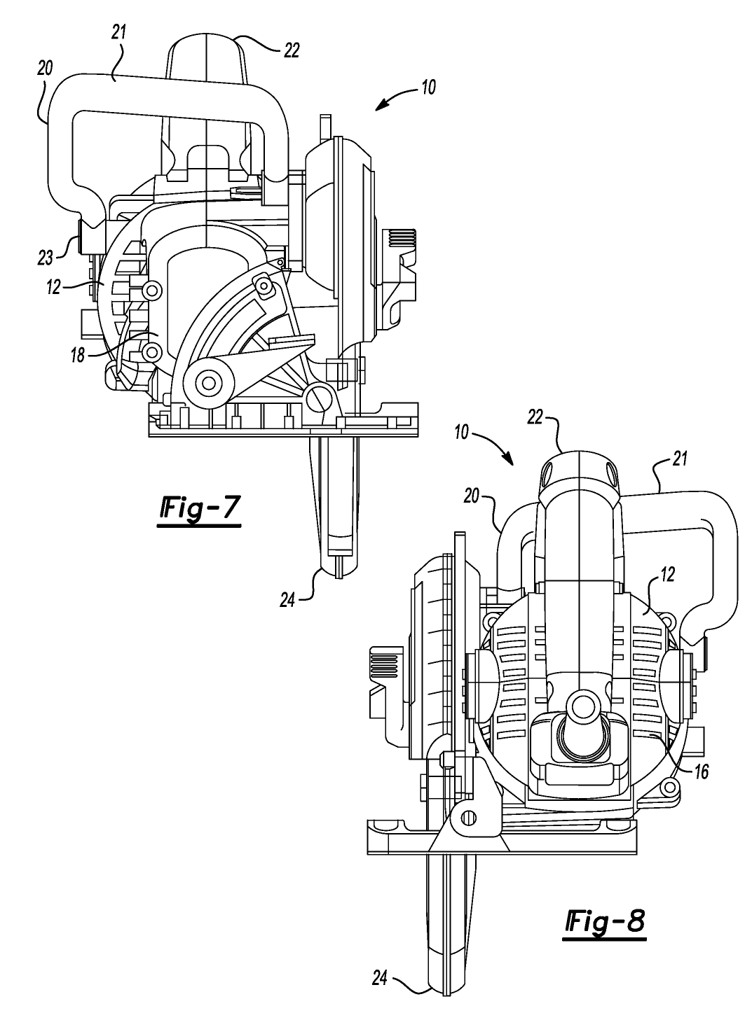

With reference to FIGS. 1-8, an exemplary worm drive saw 10 is illustrated according to the principles of the present teachings. Worm drive saw 10 comprises a motor and transmission casing 12 having a main handle assembly 14. Main handle assembly 14 can comprise an actuation trigger 15 for controlling a motor 16 and a gripping portion 17. Casing 12 can be shaped to house motor 16 and a drive transmission 18 operably coupled to motor 16 for transmitting a power drive force from motor 16 to a circular cutting blade 19 (FIG. 13). In some embodiments, drive transmission 18 can be a worm drive transmission, which will be discussed in greater detail herein. However, it should be appreciated that alternative drive transmissions can be used in connection with the specific teachings of the present disclosure where appropriate.

With continued reference to FIGS. 1-8, worm drive saw 10 can further comprise an auxiliary handle assembly 20 fixedly coupled to a top portion of casing 12. Specifically, auxiliary handle assembly 20 can comprise a generally C-shaped member having a gripping portion 21 and fastening ends 23, which are sized and configured for mounting auxiliary handle assembly 20 to casing 12 via fasteners 25. This arrangement provides a secure and balanced position for carrying and/or tethering worm drive saw 10.

In some embodiments, worm drive saw 10 can include an upper blade guard 22 coupled to or integrally formed with casing 12. Upper blade guard 22 remains in a fixed position relative to the circular cutting blade so as to protect an operator from debris and other material. A movable lower blade guard 24 is rotatably coupled to at least one of upper blade guard 22 or casing 12. More particularly, in some embodiments, lower blade guard 24 includes a hub for rotatable coupling to an output drive shaft, which will be discussed in great detail herein. Lower blade guard 24 is configured such that it moves in a rotating direction about an axis A-A (FIG. 1) of an output drive shaft when lower blade guard 24 abuts a workpiece to be cut 2000 (FIG. 13).

It has been found in some conventional blade guard designs that when cutting a workpiece at a large bevel angle (i.e. over 45 degrees) and/or when cutting a small sliver piece of the workpiece, conventional lower blade guards may not properly rotate out of position through a normal abutment relationship with the workpiece. This is typically caused by the fact that the outboard edge of many lower blade guards does not contact the workpiece during such large bevel angle and/or sliver piece cuts. In some situations, the shape of conventional lower blade guards can cause a binding engagement with the workpiece. Therefore, in conventional designs, this can result in an improper cut or the cutting blade being prevented from engaging the workpiece.

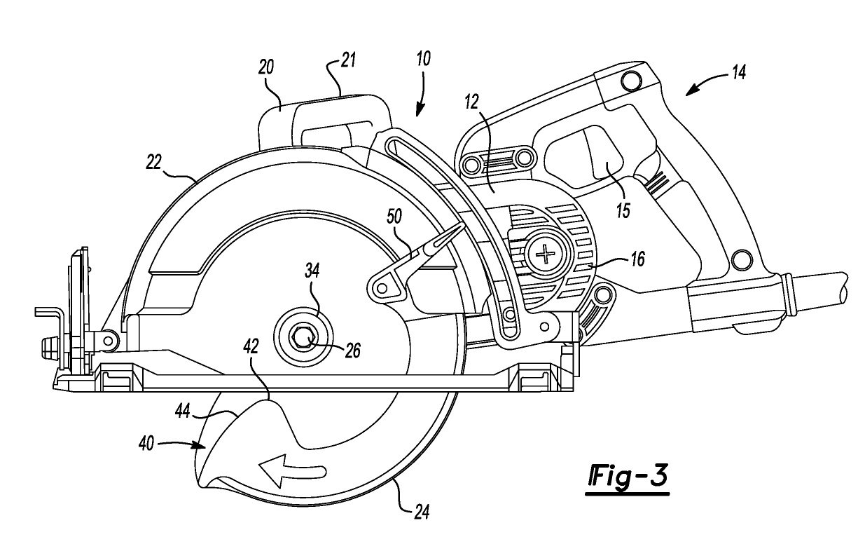

According to the principles of the present teachings, lower blade guard 24 is configured to provide an improved camming face relative to conventional lower blade guards along its outboard edge (see FIG. 9) so as to promote proper engagement with a workpiece during large bevel angle cuts and when cutting small portions of the workpiece. To this end, as illustrated in FIGS. 3 and 10-12, in some embodiments lower blade guard 24 comprises a generally half-moon shaped member concentric about a central hub 28 and a motor side surface 30 integrally formed with and radially extending from central hub 28. Central hub 28, as illustrated in FIG. 11, can comprise a collar portion 32 having an internal diameter sized to cooperate with a bearing surface 34 (FIG. 3) formed as part of at least one of casing 12, upper blade guard 22, or output drive shaft. This physical engagement of collar portion 32 of lower blade guard 24 and bearing surface 34 provides a smooth engagement for lower blade guard 24 to permit lower blade guard 24 to rotate out of position during operation in cooperation with a camming face, to be discussed.

Lower blade guard 24 further comprises an outboard side surface 36 coupled to motor side surface 30 via an edge surface 38. Accordingly, motor side surface 30, outboard side surface 36, and edge surface 38 together defined an internal volume or cavity for receiving the circular cutting blade therein. As should be understood, lower blade guard 24 is biased from a retracted position, wherein the circular cutting blade is exposed, to a concealed position, wherein the circular cutting blade is covered and protected (FIG. 3).

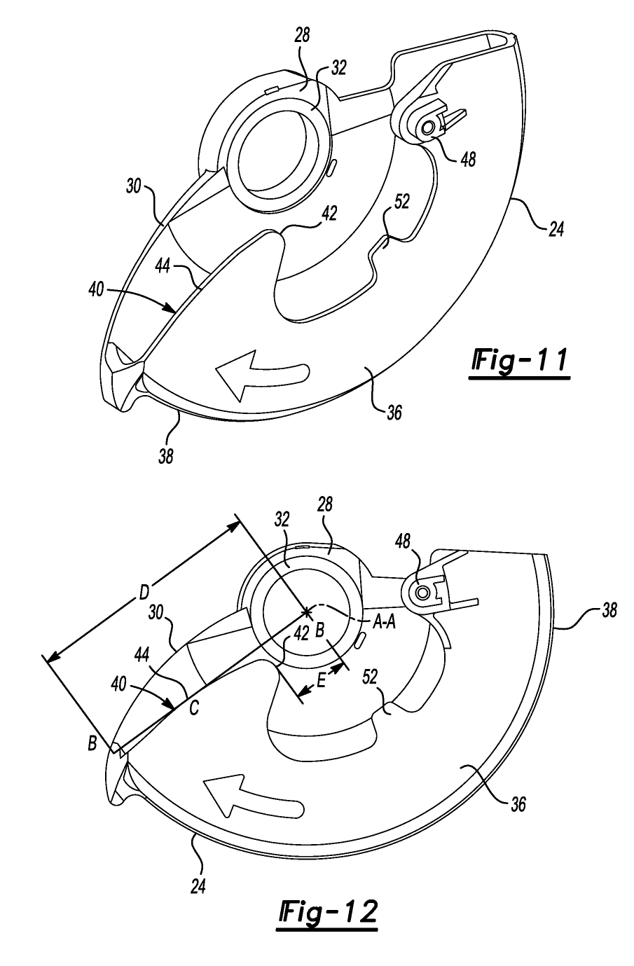

As can be seen in FIGS. 11-12, in some embodiments, outboard side surface 36 of lower blade guard 24 comprises various features which aid in the operation of worm drive saw 10. Specifically, outboard side surface 36 can comprise a cam 40 that is shaped and sized in accordance with the principles of the present teachings to provide improved workpiece engagement during large bevel angle cuts and/or small workpiece sliver cuts. Cam 40 can comprise and extend from a camming tip 42 along a camming portion 44. Camming portion 44 generally extends from camming tip 42 to edge surface 38 of lower blade guard 24.

With particular reference to FIG. 12, camming portion 44 is shaped to include a slight arcuate curve that closely follows a radial line B-B extending from axis A-A. Camming portion 44 can define a tangent point or region C relative to radial line B-B. In some embodiments, this tangent point or region C can be disposed at a position about midpoint (i.e. about 50%) along the distance D, which extends from axis A-A to an internal surface of edge surface 38. In some embodiments, this tangent point or region C can be disposed at a position about midpoint along cam 40.

The shape of camming portion 44, namely its relation to radial line B-B, produces a driving moment promoting rotation of lower blade guard 24 about axis A-A to improve operation of worm drive saw 10 during large bevel angle cuts and/or a narrow sliver cuts. It should be appreciated that camming portion 44 defines a curvature and inclination that is reduced relative to conventional lower blade guards, such as illustrated in FIG. 9.

Furthermore, according to the principles of the present teachings, camming tip 42 of cam 40 extends to a position substantially adjacent to the central axis of central hub 28. More particularly, as illustrated in FIG. 12, in some embodiments camming tip 42 can be positioned at an offset distance E that is less than 50% of distance D. In some embodiment, offset distance E of camming tip 42 can be less than 35% of distance D or even less than 25% of distance D (as shown in FIG. 12). According to this configuration, camming tip 42 can more quickly contact the workpiece during a cutting operation and, thus, begin rotation of lower blade guard 24 from its concealed position (FIG. 1) to its retracted position. Moreover, it should be appreciated that camming tip 42 defines a more elongated shape relative to conventional lower blade guards—that is, camming tip 42 extends closer to axis A-A (see FIG. 9)—and permits quicker engagement of lower blade guard 24 against a workpiece during a cutting operation.

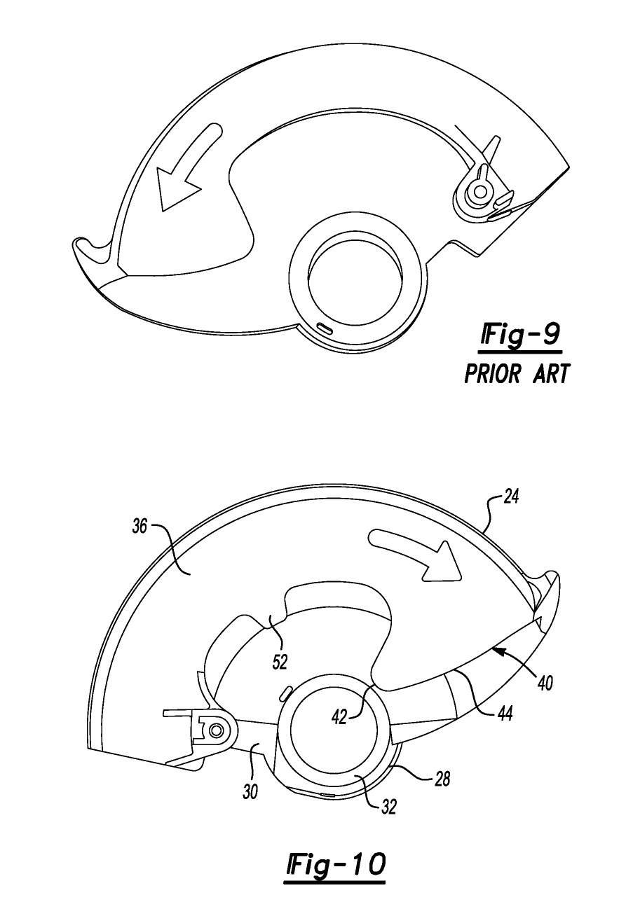

Still referring to FIGS. 10-12, lower blade guard 24 can further comprise a first connecting feature 48 for coupling a thumb lever 50 thereto (FIGS. 1 and 3). Thumb lever 50 can be used by an operator to manually rotate lower blade guard 24 from the concealed position to the retracted position without the need for workpiece abutment. Lower blade guard 24 can further comprise a thumb gripping portion 52 for use during circular cutting blade replacement to conveniently hold lower blade guard 24 in the retracted position or intermediate position for simplified access to the circular cutting blade, which will be discussed in greater detail herein. Thumb gripping portion 52 can be formed as an extension from outboard side surface 36. More particularly, thumb gripping portion 52 can be formed along a mid-section edge of outboard side surface 36 and can, in some embodiment, remain as a flat feature co-planar with outboard side surface 36. This can prevent inadvertent gripping and/or snagging of thumb gripping portion 52. Thumb gripping portion 52 can be positioned such that during a blade replacement operation, an operator can hold worm drive saw 10, at auxiliary handle assembly 20, and simultaneously hold lower blade guard 24 in a retracted position with a single hand.

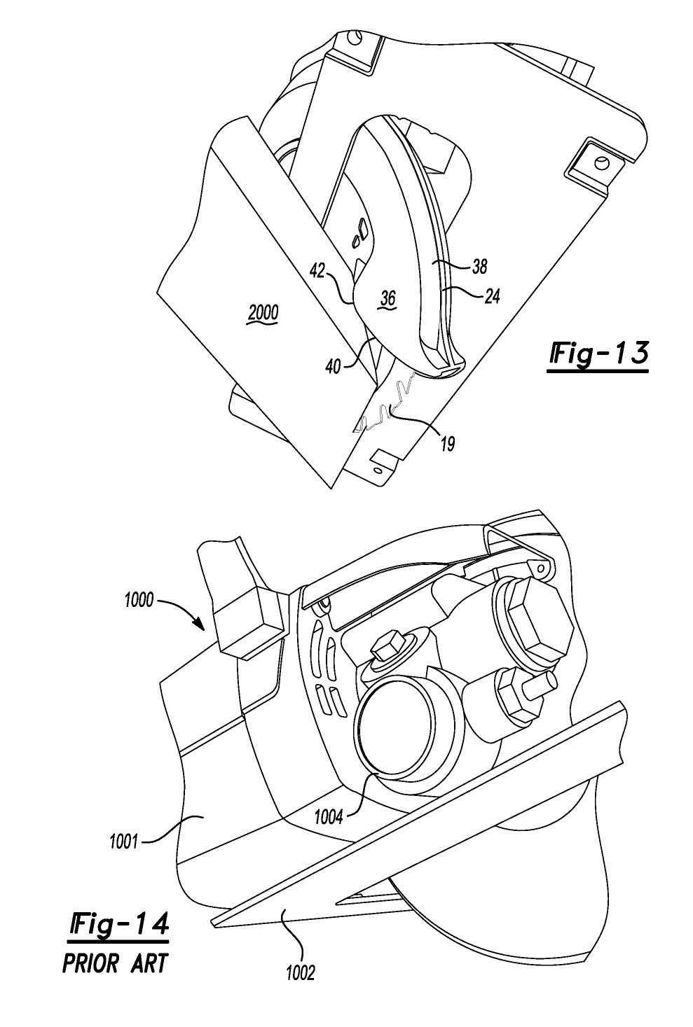

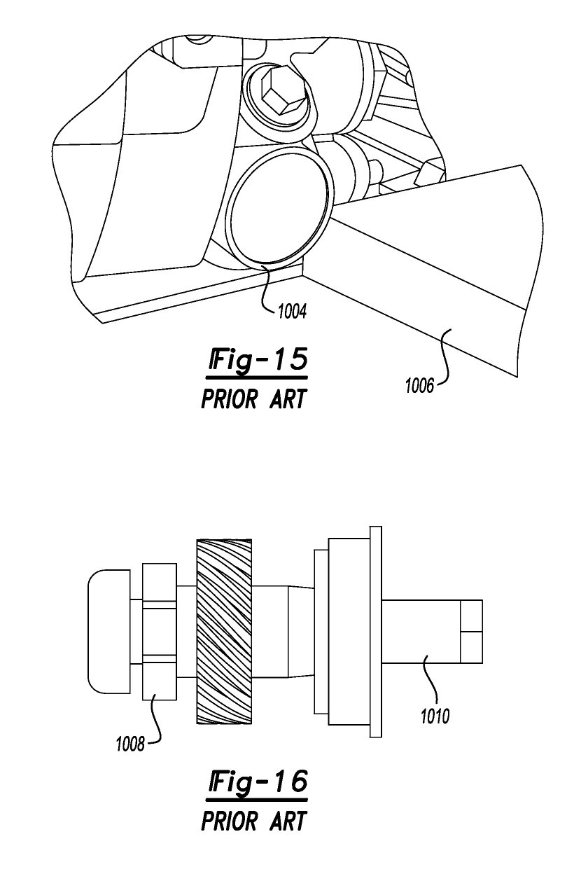

Turning now to FIGS. 14-16, a conventional worm drive circular saw 1000 is illustrated having many of the disadvantages representative of the prior art. In particular, the illustrated conventional worm drive saw suffers from the inability to provide adequate clearance between its motor casing 1001 and its corresponding rip guide 1002 (also known as rip guide clearance). As best seen in FIGS. 14-15, conventional worm drive circular saw 1000 has a protrusion 1004 resulting from the placement of internal transmission drive components (FIG. 16). That is, as illustrated in FIG. 16, conventional worm drive circular saw 1000 employs a spindle lock 1008 disposed on an output drive shaft 1010 thereby increasing the overall length of output drive shaft 1010 and causing protrusion 1004 to extend outboard from motor casing 1001.

In operation, this limits the thickness of a rip guide member 1006 (FIG. 15), such as a worksite wooden member, that can be used. For example, during operation, operators typically prefer to use any available elongated member present (i.e. rip guide member 1006) at a worksite to serve as a guide for defining a straight and even cut. This rip guide member 1006 can include any available straight cut lumber. However, during a full depth cut, wherein the conventional worm tool is adjusted such that protrusion 1004 is closely positioned relative to rip guide 1002, the thickness of rip guide member 1006 is limited due to the interference caused between rip guide member 1006 and protrusion 1004 of conventional worm drive circular saw 1000. Specifically, when conventional worm drive circular saw 1000 is configured for maximum depth cutting, protrusion 1004 provides only a half-inch clearance between the bottom of rip guide 1002 and the lower edge of protrusion 1004. Consequently, this prevents an operator from using readily-available “1×” lumber (which has a thickness of about ¾ inch).

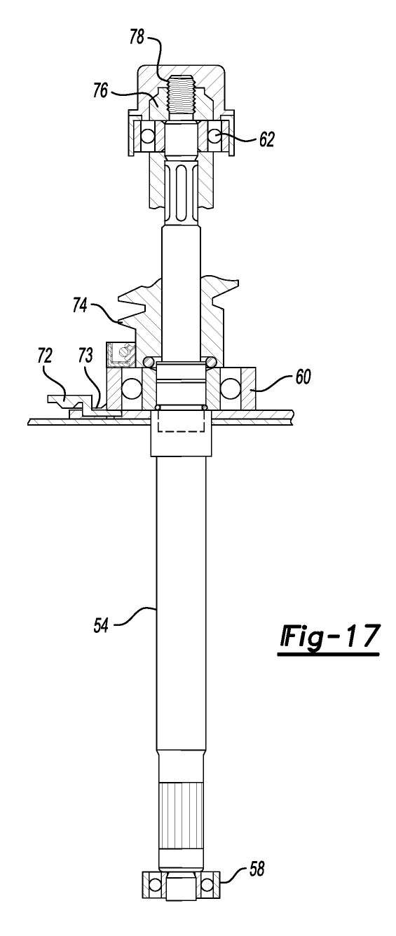

Accordingly, as illustrated in FIGS. 17-22, drive transmission 18 of worm drive saw 10 is illustrated according to the principles of the present teachings. In some embodiments, drive transmission 18 comprises an elongated armature drive shaft 54 having armature windings 56 (FIG. 19) disposed about an end thereof. Armature shaft 54 is rotatably supported between an inner bearing 58, a fan end armature bearing 60, and an outer bearing 62. Armature shaft 54 is rotatable in response to electrical impulse passing through armature windings 56 in a conventional manner thereby producing a rotationally output driving force. Drive transmission 18 can comprise a spindle lock fan hub 64 positioned at an intermediate point on armature shaft 54.

Still referring to FIG. 17, drive transmission 18 can further comprise a bearing retaining plate 72 having a recessed portion 73 formed therein sized to receive and retain fan end armature bearing 60. A worm gear 74 is fixedly coupled to armature shaft 54, such as through a key connection, for rotation therewith and in close relationship to fan end armature bearing 60. Finally, outer bearing 62 and a retaining nut 76 are positioned at an outer end 78 of armature shaft 54.

According to the principles of the present teachings, each of the components disposed along armature shaft 54 can be progressively smaller in outer diameter than the adjacent component an armature shaft 54 to provide advantages in manufacturing and operation. That is, bearing retaining plate 72, fan end armature bearing 60, worm gear 74, outer bearing 62, and retaining nut 76 can each have an outer diameter smaller than the proceeding component, respectively. This progressively sized distribution of components and the use of bearing retaining plate 72 permits preassembly of armature shaft 54 with bearing retaining plate 72, fan end armature bearing 60, worm gear 74, outer bearing 62, and retaining nut 76 and further permits such pre-assembly to be easily installed and secured within casing 12. The pre-assembly is in effect a series of concentric cylinders or cones of successively decreasing diameter. This pre-assembly can be put together outside of casing 12, then installed in casing 12 through a single penetration in casing 12. Furthermore, this pre-assembly inhibits separation of such components due to gear drive forces. Still further, this pre-assembly reduces the amount of machining necessary on casing 12 and, thus, minimizes the number of holes that must be created in casing 12. This in turn reduces the opportunities for lubrication leakage.

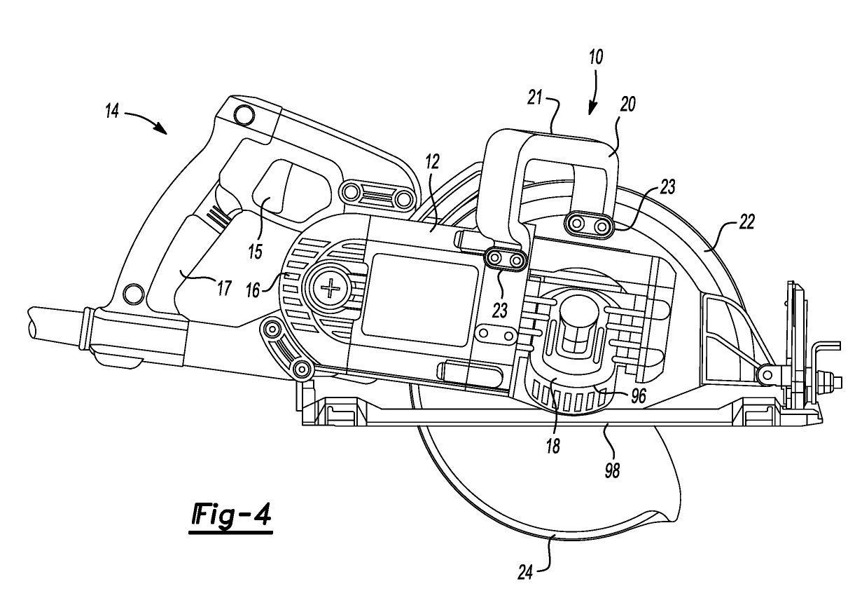

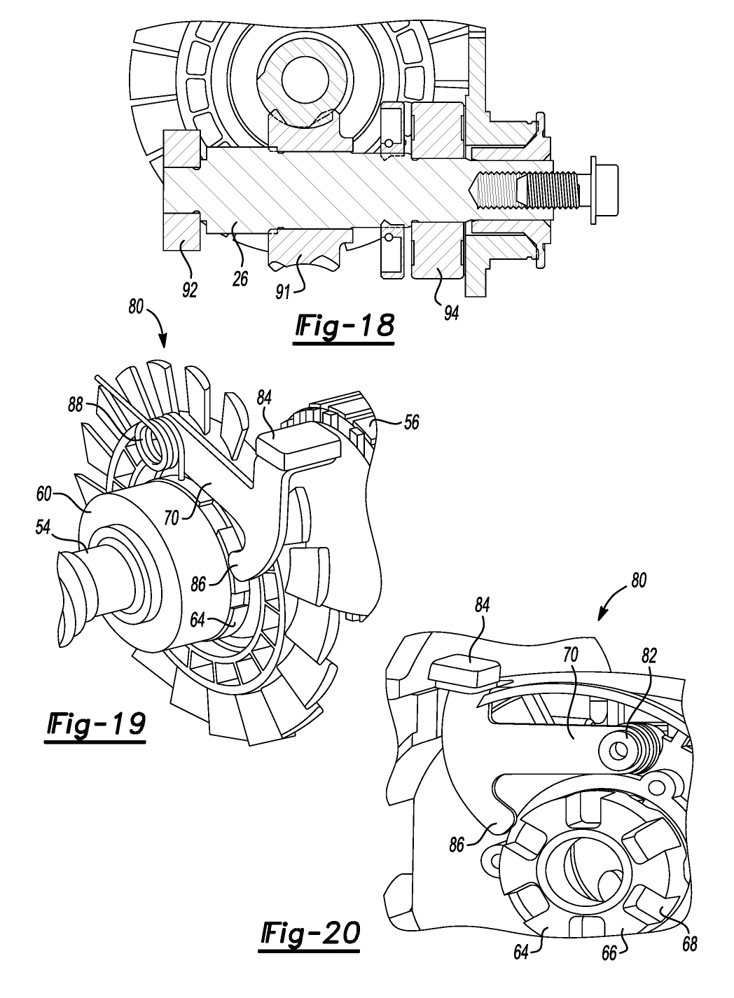

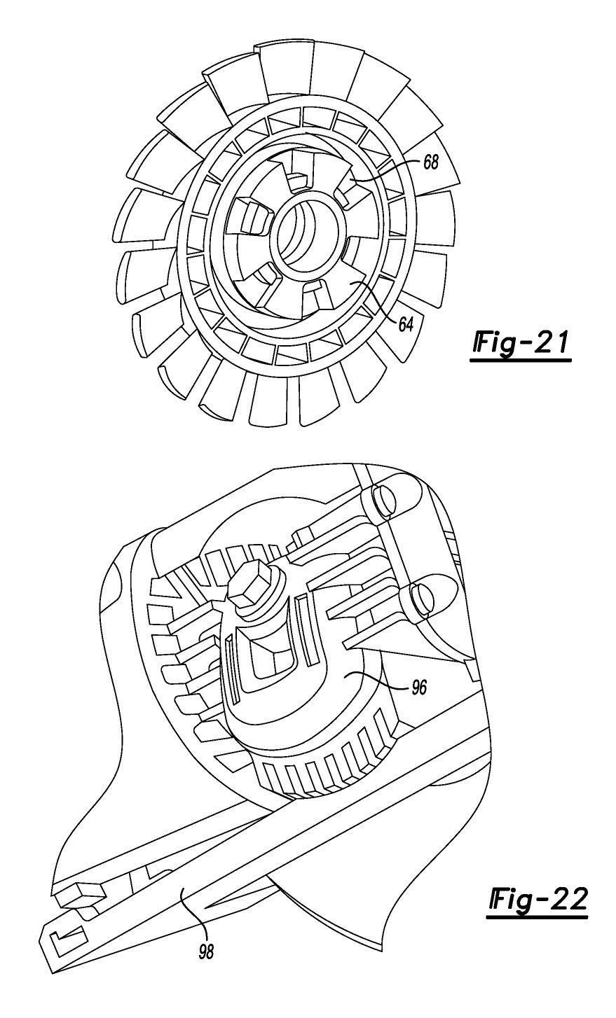

Referring now to FIG. 18, drive transmission 18 further comprises output drive shaft 26 having a corresponding worm gear 91 fixedly coupled thereto for rotation therewith and sized to enmeshingly engage worm gear 74 of armature shaft 54. Output drive shaft 26 can be supported for rotation by a first output drive shaft bearing 92 and a second output drive shaft bearing 94. It should be appreciated, as illustrated in FIG. 18, that the removal of the conventional spindle lock feature 1012 (FIG. 16) on conventional output drive shaft 1014 (FIG. 16) enables first output drive shaft bearing 92 to be moved to the right in the figure (FIG. 18). This movement of first output drive shaft bearing 92 to a more inboard location minimizes the protrusion effect (i.e. protrusion 1004) found on the exterior of conventional worm drive circular saw 1000. Therefore, according the principles of the present teachings, worm drive saw 10 is able to achieve a greater distance between the lower portion of protrusion 96 and the lower edge of rip guide 98 (see FIGS. 4 and 22). Therefore, an operator can now use a standard (1×) wooden rip guide member having a thickness of about ¾ inch at a maximum depth cut setting. It should be appreciated that this is achieved due to the novel configuration of spindle lock mechanism 80 and the inboard relocation of first output drive shaft bearing 92 relative to conventional worm drive circular saw 1000. These advantages are also resultant from the novel configuration of a spindle lock mechanism.

Referring again to FIGS. 17-21, a spindle lock mechanism 80 is illustrated according to the principles of the present teachings. With particular reference to FIGS. 19-21, in some embodiments, spindle lock mechanism 80 comprises spindle lock member 70 engagable with hub portion 66 of spindle lock fan hub 64. Specifically, spindle lock member 70 can comprise a generally T-shaped member pivotally coupled to casing 12 or an intermediate surface at a pivot 82. Spindle lock member 70 further comprises a thumb pad 84 and a locking tab 86 opposite thereof. As seen in FIGS. 17-21, spindle lock fan hub 64 can comprise a hub portion 66 having a plurality of cavity locks 68 radially formed therein. Each cavity lock 68 includes a generally U-shaped depression accessible and engagable locking tab 86 of spindle lock member 70. It should be appreciated that variations exist as to the exact size, shape, and relative movement of spindle lock member 70 and spindle lock fan hub 64. Spindle lock mechanism 80 can further comprise a biasing spring 88 sufficiently sized to urge spindle lock member 70 into a disengaged position relative to spindle lock fan hub 64.

During operation, an operator can depress thumb pad 84 of spindle lock member 70 to overcome the biasing force of biasing spring 88 and cause the insertion of locking tab 86 into one of the plurality of cavity locks 68 in spindle lock fan hub 64. Because spindle lock member 70 engages spindle lock fan hub 64 on armature shaft 54, a small turn of the circular cutting blade will cause many turns of armature shaft 54 and thus give many opportunities for engagement of locking tab 86 in one of the plurality of cavity locks 68, unlike conventional systems that use a spindle lock in connection with the output drive shaft.

According to this arrangement, it should be appreciated that thumb pad 84 is positioned adjacent to auxiliary handle assembly 20 and in sufficiently close proximity such that an operator can hold worm drive saw 10 in one hand while simultaneously actuating thumb pad 84 with the same hand. This arrangement thus enables the operator to hold the power tool, prevent rotation of the circular cutting blade, and replace the circular cutting blade, without the need to place worm drive saw 10 on the ground or other supporting structure and in a favorable position. In some embodiments, an operator can further retract lower blade guard 24 using thumb gripping portion 52 during the above replacement operation.

It should again be understood that the spindle lock mechanism and/or transmission drive system can be adapted for use in other power tools.

What is claimed is:

1. A power tool comprising:
a casing;
a motor disposed at least partially in said casing;
a drive transmission operably coupled to said motor, said drive transmission outputting a driving force in response to an input from said motor;
a circular cutting blade drivingly coupled to said drive transmission; and
a movable blade guard pivotally coupled about an axis relative to said casing, said movable blade guard having an inboard surface, an outboard surface, and an edge surface defining a cavity for receiving said circular cutting blade, said outboard surface defining a cam having a camming tip and camming portion interconnecting said camming tip, said camming portion defining an edge extending substantially along a radial line from said axis.

2. The power tool according to claim 1, wherein said cam defines a tangent point relative to a radial line extending from said axis, said tangent point being at a position generally midpoint on said cam.

3. The power tool according to claim 1, wherein said camming tip is positioned at a point less than 50% of a distance from said axis to said edge surface.

4. The power tool according to claim 3, wherein said camming tip is positioned at a point less than 35% of said distance from said axis to said edge surface.

5. The power tool according to claim 3, wherein said camming tip is positioned at a point less than 25% of said distance from said axis to said edge surface.

6. A circular cutting saw for cutting a workpiece, said circular cutting saw comprising:
a casing;
a motor disposed at least partially in said casing;
a drive transmission operably coupled to said motor, said drive transmission outputting a driving force in response to an input from said motor;
a circular cutting blade drivingly coupled to said drive transmission; and
a movable blade guard pivotally coupled about an axis relative to said casing, said movable blade guard having an inboard surface, an outboard surface, and an edge surface defining a cavity for receiving said circular cutting blade, said outboard surfacing having a cam engagable with the workpiece at a camming tip and subsequently along a camming portion, said camming tip and said camming portion providing a non-binding engagement and rotational movement of said movable blade guard during cutting operations when only said outboard surface contacts the workpiece.

7. The circular cutting saw according to claim 6, wherein said camming portion is shaped to extend substantially along a radial line from said axis.

8. The circular cutting saw according to claim 6, wherein said cam defines a tangent point relative to a radial line extending from said axis, said tangent point being at a position generally midpoint on said cam.

9. The circular cutting saw according to claim 6, wherein said camming tip is positioned at a point less than 50% of a distance from said axis to said edge surface.

10. The circular cutting saw according to claim 9, wherein said camming tip is positioned at a point less than 35% of said distance from said axis to said edge surface.

11. The circular cutting saw according to claim 9, wherein said camming tip is positioned at a point less than 25% of said distance from said axis to said edge surface.
